(19) United States
(12) Patent Application Publication
(10) Pub. No.: US 2002/0169398 A1
(43) Pub. Date: Nov. 14, 2002

(54) Therapeutic massage and heating pad

(76) Inventor: Tammy E. Hancock, Ceres, VA (US)

Correspondence Address: Donald W. Spurrell, P.O. Box 970, Johnson City, TN, 37605, US

(21) Appl. No.: 09/854,833

(22) Filed: May 14, 2001

(51) Int. Cl. A61H 1/00

(52) U.S. Cl. 601/15; 601/46

(57) ABSTRACT

A tubular elongated, pillow like, comfortable pad body containing heating and vibratory devices which are controllable by the wearer, wherein an elastic segment extends substantially longitudinally of the body and divides the body longitudinally and provides radial expandability thereto whereby a persons limb can be inserted longitudinally thru the body such that the body is elastically held in a desired longitudinal and angular position on the limb, and wherein Velcro straps or the like are provided generally laterally on the body to further tighten the body around the limb where such tightening is desired.

### BACKGROUND OF THE INVENTION

1. Field of the Invention

This invention concerns therapeutic pads which combine massage and heating functions and in particular to such pads provided in a variety of sizes and shapes to accommodate different portions of the human body, particularly the arms and legs and which is operable from either battery power or line power such as standard 110 or 220 volts A.C.

2. Prior Art

Many devices and apparatus have been designed to provide therapeutic heating and/or massaging or vibration for application to various portions of the human body as shown in U.S. Pat. Nos. 4,979,502; 4,177,796; 3,710,784; 4,607,624; 3,323,517; 2,431,525; 3,062,203; 3,457,910; 4,559,929; 4,136,685; and 3,981,032, the disclosures of all of which are hereby incorporated herein in their entireties, and particularly with respect to the vibratory and heating devices and their controls.

The structures shown in these patents, while perhaps suitable for some specific purposes, do not suggest or provide the comfortable, convenient, and highly effective utilitarian and therapeutic aspects which are the objects of the present invention.

### SUMMARY OF THE INVENTION

The present invention, in one of its preferred embodiments comprises a tubular pillow like, comfortable pad body having distal and proximal ends and containing heating and vibratory devices which are controllable by the wearer, wherein an elastic segment extends substantially longitudinally of the body and divides the body longitudinally and provides radial expandability thereto whereby a persons limb can be inserted longitudinally thru the body such that the body is elastically held in the desired longitudinal and angular position on the limb, and wherein Velcro straps or the like are provided generally laterally on the body to further tighten the body around the limb where such tightening is desired.

### BRIEF DESCRIPTION OF THE DRAWINGS

The invention will be further understood from the following description and drawings wherein:

FIG. 1 is a top down view of the present pad structure with portions broken away or dotted for clarity; and

FIG. 2 is a side view taken in the direction of line 2-2 of FIG. 1 in the direction of the arrows, and with portions broken away for clarity.

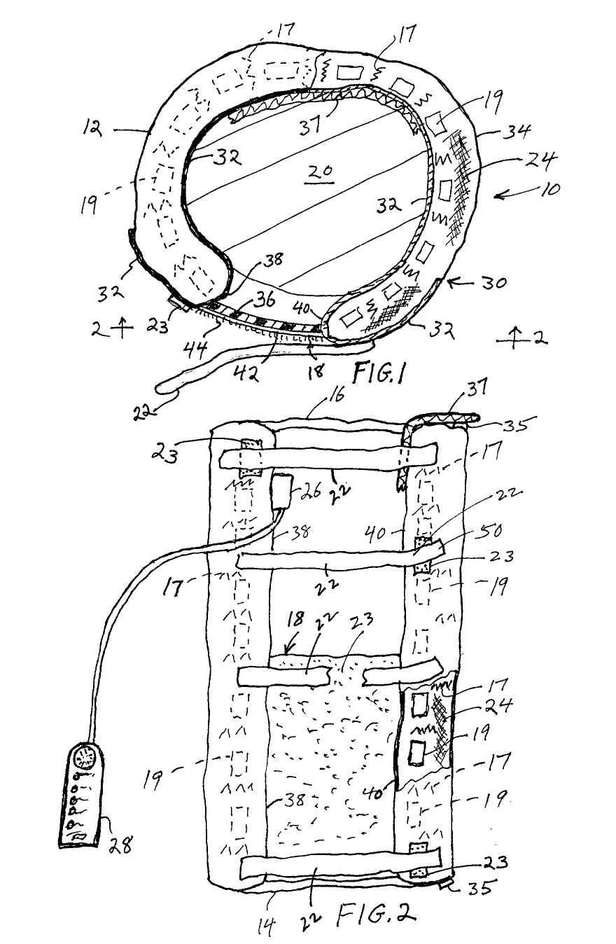

### DETAILED DESCRIPTION OF THE DRAWINGS

Referring to the drawings and with particular reference to the claims and summary herein, the present invention 10, in one of its preferred embodiments comprises a tubular, pillow like, comfortable pad body 12 having distal 14 and proximal 16 ends and containing heating 17 and vibratory 19 devices which are controllable by the wearer, wherein an elastic segment 18 extends substantially longitudinally of the body to divide the same and provides radial expandability thereto whereby a persons limb 20 can be inserted longitudinally thru the body and the body elastically held in position on the limb, and wherein tightening straps such as straps 22 and counterparts 23 are provided on the body and either span the elastic segment or affixes thereto to tighten the pad body around the limb. It is noted that when the straps are tightened, segment 18 is normally urged radially inwardly to contact limb 20.

The pad body for use, e.g., on an adult persons leg, preferably has a wall thickness “T” of from about 1-2 in., an I.D. of from about 3 to about 8 in., a total length of about 24 in., and an elastic segment 18 extending approximately one half the way up from distal end 14. Especially small or large limbs may require other sizes. The pad body fill material 24 can be of any soft material, preferably of a flexible soft texture such as polyester fiberfill, cotton, wool, or soft polyurethane foam or the like which can withstand temperatures of at least about 150° F., and constant vibration over extended periods.

The electrical heating and vibratory devices, e.g., electromagnet-permanent magnet combination, are disclosed in the aforementioned prior patents, particularly U.S. Pat. No. 4,177,796 for a useful vibratory device. A transformer such as 26 mounted on the pad allows the use of line or home voltage for operating low voltage heating and vibratory devices, and a remote control 28 such as a CONAIR® Model BMS 10M is electrically connected to the transformer output and to the inputs of the heaters and vibratory devices, and is adapted to control the operations of these devices with regard to elastomeric or foam rubber or the like component 36 joined to edge portions 38, 40 of the pad.

The pad may be provided with any number of attachment elements 35 such as Velcro components, snap fastener or the like, which are located preferably on the exterior surfaces of coving 30 whereby an inner specially textured lining 37 can be removably affixed to the pad. This lining, only a portion of which is shown, can extend over any portion or all of the inner surface of section 32 or can actually replace section 32. This lining can comprise such materials as Loofa sponge, surgical brush, sponge, sheeps wool or terry cloth, depending on the wearers skin condition, comfort requirements, or the like.

An elastic Velcro component 42 preferably is affixed by rubber cement or the like to the outer surface of 36 and imparts additional strength to 36 as well as providing loops or hooks 44 as a component of tightening straps 22 which constitutes the other component of a Velcro attachment. These straps, of any number, and their Velcro components can span or affix to the elastic segment 18 such that edge portions 38 and 40 can be drawn together to tighten the pad against the limb when desired.

An important aspect of the present invention is that segment 18 extends upwardly relative to FIG. 2 only from about ⅓ to about ⅔ the total length of the pad such that with the straps loosened, the limb can easily be inserted down thru the segment 18 portion of the pad to a desired precise longitudinal and angular position where segment 18 elastically retains the pad in that position both before and after the straps 22 are tightened.

The invention has been described in detail with particular reference to preferred embodiments thereof, but it will be understood that variations and modifications will be effected with the spirit and scope of the invention.

I claim:

1. A therapeutic, elongated, combination massage and heating pad structure having a generally tubular portion having a primary axial dimension and comprised of a substantially non-elastic segment, and an elastic segment having a secondary axial dimension, said elastic segment longitudinally dividing said non-elastic segment to form opposing longitudinally extending edge portions of said non-elastic segment, said elastic segment adapted to be radially expanded whereby said pad structure can be slid over a persons limb to its operable position wherein said pad structure will snugly encompass said limb, electrically operable vibrator means distributed within said pad structure for producing vibrational massaging forces to said limb, first electrical control means associated with said vibrator means for selectively controlling the location and amplitude of the massaging forces generated by said vibrator means, electrical heater means distributed within said pad structure for providing therapeutic heat to selected portions of said limb, second electrical control means associated with said heater means for controlling the temperature output and heating location thereof, and strap means on said pad structure adapted to pull said edge portions of said non-elastic segment together to further compress said pad structure against said limb.

2. The pad structure of claim 1 wherein said elastic material extends from about ½ to about ⅔ the way from a distal end of said pad structure to a proximal end of said structure and wherein said non-elastic segment is comprised of a closed covering of flexible material providing a chamber, wherein said chamber is filled with cushion material.

3. The pad structure of claim 1 wherein said elastic segment is comprised of soft rubber or elastomeric material.

4. The pad structure of claim 2 wherein attachment means are provided thereon for removably positioning a specially textured lining on the inner surface of said tubular portion.
